(19) United States
(12) Patent Application Publication
(10) Pub. No.: US 2013/0027255 A1
(43) Pub. Date: Jan. 31, 2013

(54) RADIO APPARATUS

(71) Applicants: Takayoshi ITO, Yokohama-shi (JP); Makoto Higaki, Kawasaki-shi (JP); Hiroki Shoki, Tokyo (JP); Shuichi Obayashi, Yokohama-shi (JP)

(72) Inventors: Takayoshi ITO, Yokohama-shi (JP); Makoto Higaki, Kawasaki-shi (JP); Hiroki Shoki, Tokyo (JP); Shuichi Obayashi, Yokohama-shi (JP)

(21) Appl. No.: 13/571,523

(22) Filed: Aug. 10, 2012

Related U.S. Application Data
(63) Continuation of application No. PCT/JP2010/000897, filed on Feb. 15, 2010.

(51) Int. Cl. H01Q 1/24; H01Q 1/52

(52) U.S. Cl. 343/702

(57) ABSTRACT

A radio apparatus according to one aspect of the embodiments includes a substrate configured to have a high-frequency circuit formed thereon. The high-frequency circuit includes an electromagnetic wave radiation source to radiate an electromagnetic wave. The radio apparatus also includes a shielding case configured to house the substrate and have a plurality of openings each having a length of half a wavelength of the electromagnetic wave in a direction orthogonal to a polarization of the electromagnetic wave. Each of the openings is provided to make each distance between centers of the openings to be shorter than one wavelength of the electromagnetic wave.

### CROSS-REFERENCE TO RELATED APPLICATION

This application is a continuation application of prior International Application No. PCT/JP2010/000897 filed on Feb. 15, 2010; the entire contents of all of which are incorporated herein by reference.

### FIELD

Embodiments described herein relate generally to a radio apparatus including a high-frequency circuit substrate including an electromagnetic wave radiation source that radiates an electromagnetic wave with predetermined frequency, and a shielding case housing the high-frequency circuit substrate.

### BACKGROUND

A noise electromagnetic wave (radiation noise) which is unintentionally generated at a time of operating an electronic apparatus such as a personal computer is called as an unwanted radiation. The generation of unwanted radiation becomes a cause of EMI (Electromagnetic Interference). With respect to such radiation noise, a radiation limit value in a frequency band of 30 MHz to 6 GHz is specified by CISPR 22 being the international standard.

Conventionally, as a measure of suppressing the unwanted radiation such as the radiation noise, provision of conductor layer on an internal surface of a case of an electronic apparatus has been widely conducted. The conductor layer formed on the internal surface of the case is formed through a method in accordance with usage such as, for example, arrangement of metal plate, coating of conductive coating material, electroless plating, and vacuum evaporation. The conductor layer formed on the internal surface of the case as above functions as an electromagnetic wave shielding that shields a noise radiated from a circuit substrate disposed in the case.

However, when an antenna for high-frequency radio communication is built in the inside of the case in which the conductor layer is provided, there is a problem that even a radio wave used for communication is shielded by the conductor layer, resulting in that the intended communication cannot be realized. In this case, it is also possible to consider that the conductor layer only in a direction in which a communication radio wave is radiated is removed to partially remove the electromagnetic shielding, but, there arises a problem that a new measure against the radiation noise becomes necessary with respect to the removed area.

A radio apparatus according to one aspect of the embodiments includes a substrate configured to have a high-frequency circuit formed thereon. The high-frequency circuit includes an electromagnetic wave radiation source to radiate an electromagnetic wave. The radio apparatus also includes a shielding case configured to house the substrate and have a plurality of openings each having a length of half a wavelength of the electromagnetic wave in a direction orthogonal to a polarization of the electromagnetic wave. Each of the openings is provided to make each distance between centers of the openings to be shorter than one wavelength of the electromagnetic wave.

According to embodiments, it is possible to provide a radio apparatus capable of realizing high-frequency radio communication while sufficiently maintaining a suppression effect of radiation noise.

### BRIEF DESCRIPTON OF THE DRAWINGS

FIG. 1 is a sectional diagram illustrating an entire configuration of a radio apparatus according to a first embodiment.

FIG. 2 is a diagram illustrating, in an enlarged manner, a periphery of an electromagnetic wave radiation part of a shielding case in the radio apparatus according to the first embodiment.

FIG. 3 is a diagram illustrating an example of openings of the shielding case in the radio apparatus according to the first embodiment.

FIG. 4 is a diagram illustrating a calculation model of the openings of the shielding case in the radio apparatus according to the first embodiment.

FIG. 5 is a diagram illustrating a calculation result based on the calculation model of the openings of the shielding case illustrated in FIG. 4.

FIG. 6 is a diagram illustrating another example of the openings of the shielding case in the radio apparatus according to the first embodiment.

FIG. 7 is a diagram illustrating still another example of the openings of the shielding case in the radio apparatus according to the first embodiment.

FIG. 8 is a sectional diagram illustrating an entire configuration of a radio apparatus according to a second embodiment .

FIG. 9 is a diagram illustrating, in an enlarged manner, a periphery of an electromagnetic wave radiation part of a shielding case in the radio apparatus according to the second embodiment.

### DETAILED DESECRIPTION

### First Embodiment

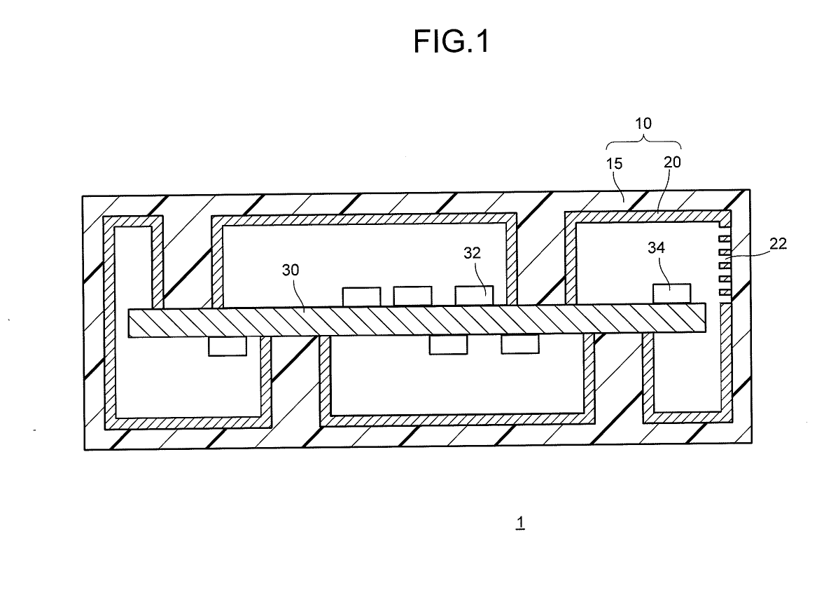

Hereinafter, embodiments will be described in detail with reference to the drawings. As illustrated in FIG. 1, a radio apparatus 1 of this embodiment includes a shielding case 10 having a main body 15 having a dielectric material and a conductor layer 20 formed on an internal surface of the main body 15 . The shielding case 10 houses a substrate 30 on which circuit modules such as an electronic component 32 and an electromagnetic wave radiation component 34 are arranged. The main body 15 has a box shape, and in an inside thereof, there are formed a space for housing the substrate 30 and projecting portions for fixing the substrate 30. The substrate 30 is fixed to the main body 15 by not-illustrated screws and the like.

The main body 15 forms an external appearance of the shielding case 10, and holds the substrate 30. The conductor layer 20 is formed of a conductive material such as copper, for example, and is formed to surround the substrate 30, and the electronic component 32 and the electromagnetic wave radiation component 34 and the like on the substrate 30. Specifically, the conductor layer 20 functions as a shielding that shields an unwanted radiation radiated from the electronic component 32 and the electromagnetic wave radiation component 34 on the substrate 30. In addition, the conductor layer 20 is provided with a plurality of slits, holes and the like at a position corresponding to the electromagnetic wave radiation component 34 (position corresponding to a radiation direction of the electromagnetic wave radiated by the electromagnetic wave radiation component 34). Hereinafter, the plurality of slits, holes and the like provided to the conductor layer 20 are called as an electromagnetic wave radiation part 22.

The electromagnetic wave radiation part 22 is provided by forming a plurality of slits, holes and the like on the conductor layer 20 that forms an inside wall of the shielding case 10, and makes an electromagnetic wave with predetermined frequency radiated by the electromagnetic wave radiation component 34 pass therethrough. Specifically, the conductor layer 20 radiates the electromagnetic wave with predetermined frequency radiated by the electromagnetic wave radiation component 34 (desired electromagnetic wave used for communication and the like, for example) to the outside of the shielding case 10 via the electromagnetic wave radiation part 22, and takes in the electromagnetic wave with predetermined frequency from the outside via the electromagnetic wave radiation part 22 to shield an unwanted radiation other than the electromagnetic wave with predetermined frequency.

On a surface of the substrate 30, a conductor layer forming an electronic circuit is formed and electrically connected to the electronic component 32, the electromagnetic wave radiation component 34 and the like disposed on a main surface. The electronic component 32 is a functional element forming an electronic circuit, such as an integrated circuit component, a resistor and a capacitor, for example. The electromagnetic wave radiation component 34 is a functional element such as an antenna element, a laminated element in which an antenna is built, and an integrated circuit element having an antenna function. The substrate 30 is formed to exert a radio communication function of the radio apparatus 1, with the use of these electronic component 32, electromagnetic wave radiation component 34 and the like.

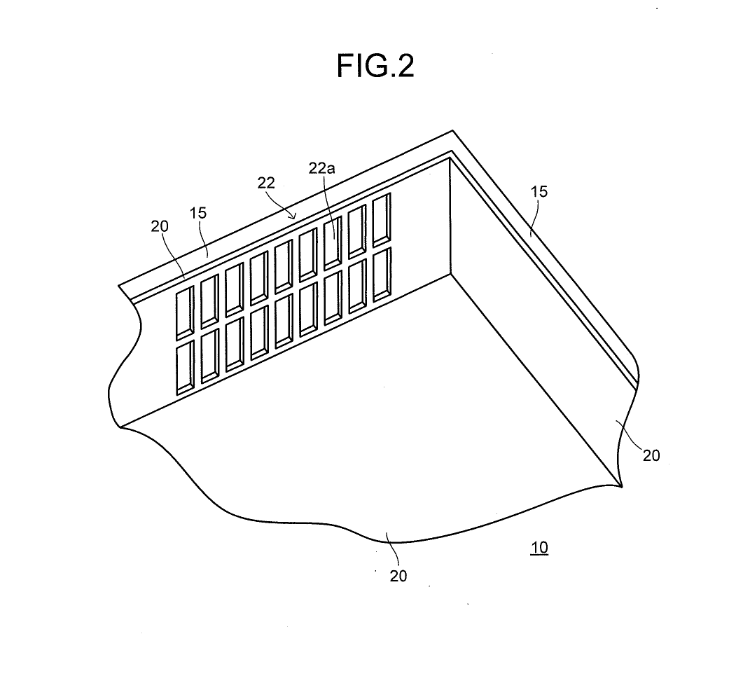

As illustrated in FIG. 2, the electromagnetic wave radiation part 22 of this embodiment has a plurality of slits each formed in a rectangular shape, on the conductor layer 20 that forms the inside wall of the shielding case 10. The slits forming the electromagnetic wave radiation part 22 are arranged in parallel, and are formed at a position on the conductor layer 20 corresponding to a position at which the electromagnetic wave radiation component 34 is disposed. The slits function as openings through which the electromagnetic wave with desired frequency radiated by the electromagnetic wave radiation component 34 passes.

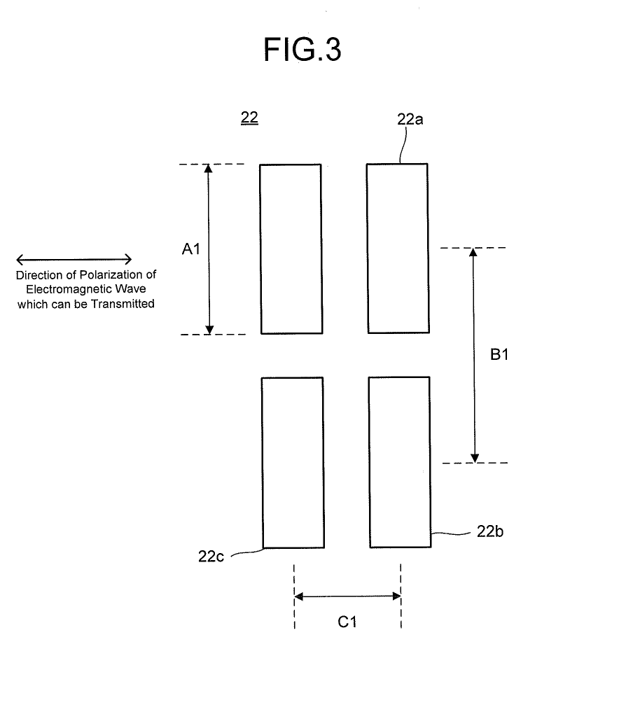

Next, the electromagnetic wave radiation part 22 of this embodiment will be described in detail with reference to FIG. 3. As illustrated in FIG. 3, the electromagnetic wave radiation part 22 of this embodiment has rectangular slits (slits 22a to 22c) each having a length A1 being half a wavelength of a desired frequency, and a width being an arbitrary length. The respective slits 22a to 22c are periodically formed in a parallel manner. Further, the positions of the electromagnetic wave radiation part 22 and the electromagnetic wave radiation component 34 are decided so that a direction of polarization of the electromagnetic wave radiated by the electromagnetic wave radiation component 34 becomes orthogonal to a longitudinal direction of the slit (direction of A1 which is set as half the wavelength of desired frequency) . In the example illustrated in FIG. 3, when the length A1 in a vertical direction of the slits 22a to 22c is set to the length being half the wavelength of the electromagnetic wave to be passed, the electromagnetic wave to be passed corresponds to a horizontal polarization. Specifically, the electromagnetic wave radiated by the electromagnetic wave radiation component 34 is set to the horizontal polarization.

If the slits being the openings are formed to have the length as described above and formed in the positional relation as described above, an electromagnetic field of half-wave fundamental mode is excited on the openings, which enables an electromagnetic wave centered at a desired frequency to pass through the shielding case. Therefore, it is possible to suppress a loss in the electromagnetic wave passing through the slits, in a frequency band around the desired frequency.

Further, each of an interval B1 in the longitudinal direction of respective slits (interval between centers, when a center of each of the slits 22a and 22b is set as a reference), and an interval C1 in a short-side direction of the respective slits (interval between centers, when a center of each of the slits 22b and 22c is set as a reference), is set to have a length being equal to or less than one wavelength. If each of the center intervals B1 and C1 of the adjacent slits becomes longer than one wavelength, frequencies cancelled by the electromagnetic field on each slit repeatedly appear, resulting in that the electromagnetic wave with desired frequency radiated by the electromagnetic wave radiation part 22 attenuates. For this reason, it is desired to set each of the intervals B1, C1 of the respective slits to the interval which is equal to or less than one wavelength of desired frequency.

### Simulation of First Embodiment

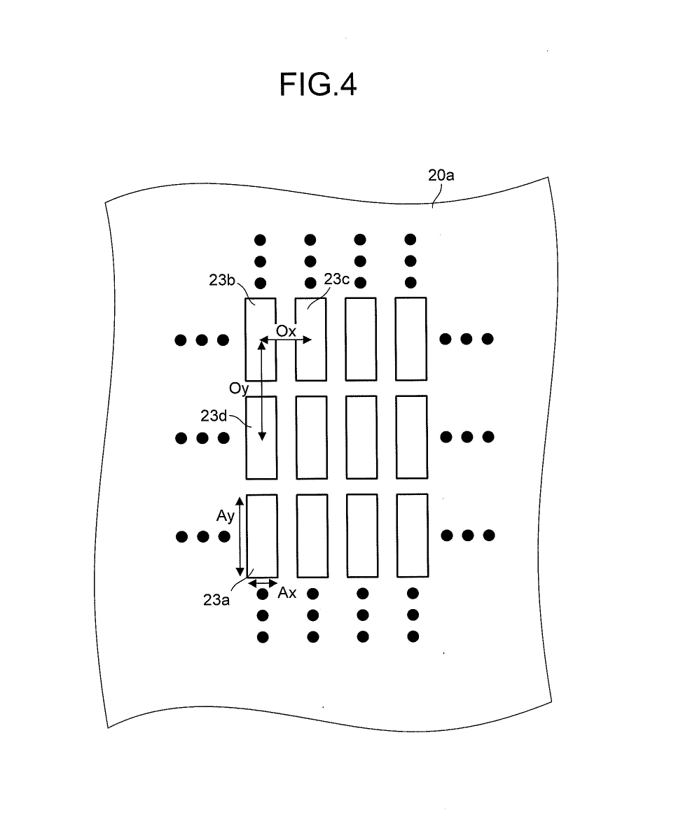

Here, by assuming that a conductive surface 20a has an unlimited space, a computer simulation is conducted with respect to a model in which slits 23a to 23d each having a width of Ax and a length of Ay are periodically formed on the conductive surface 20a, as illustrated in FIG. 4. If a wavelength in a desired frequency is set to λ, a size of the slit is 0.2λ of Ax and 0.5λ of Ay, a center distance Ox of adjacent slits is 0.5λ, and Oy, which is also a center distance, is 0.7λ.

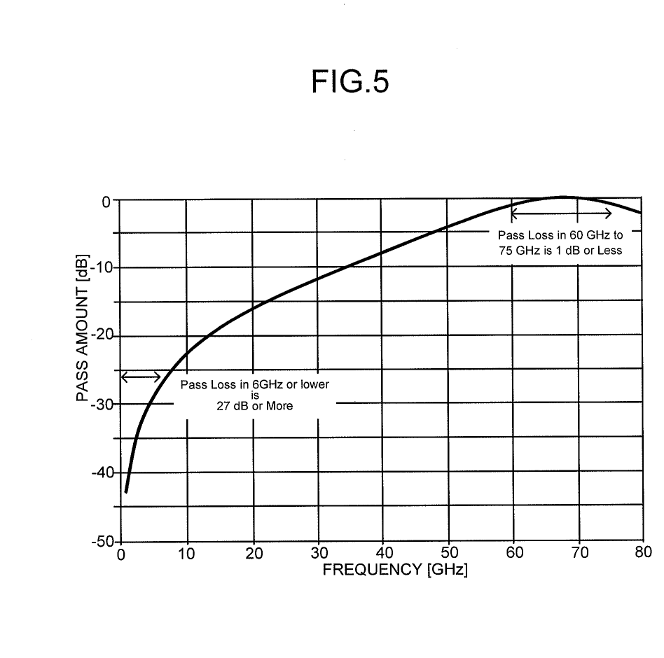

FIG. 5 is a diagram illustrating a result of the simulation. As illustrated in FIG. 5, a pass loss in a frequency band of 60 GHz to 75 GHz is 1 dB or less, and it can be understood that radio waves in this frequency band can be sufficiently passed. On the other hand, a pass loss in a frequency band of 6 GHz or less is 27 dB or more, and it can be understood that it is possible to effectively suppress an unwanted radiation such as a radiation noise centered at a low frequency band.

The international standard CISPR22 specified by CISPR (International Special Committee on Radio Interference) being one of special committees of IEC (International Electrotechnical Commission) and dealing with matters related to EMC (Electromagnetic Compatibility) specifies that a permissible value of radiation noise from an information technology apparatus is up to 6 GHz at the maximum. In like manner, within the country, a regulation which is substantially the same as that of CISPR22 is also set by the VCCI Council. Therefore, it becomes important how much of the radiation noise of 6 GHz or less is suppressed, as performance of shielding case that shields electromagnetic waves.

The result of computer simulation illustrated in FIG. 5 indicates that, if a frequency of electromagnetic wave radiated by the electromagnetic wave radiation component 34 is set to 60 GHz, for example, a radiation noise of 6 GHz or less can be sufficiently suppressed while making a desired electromagnetic wave sufficiently pass via the electromagnetic wave radiation part 22, and it can be understood that the electromagnetic wave can be selectively shielded.

### (Shape of Opening)

In the embodiment illustrated in FIG. 2 and FIG. 3, the electromagnetic wave radiation part 22 has the openings each having a rectangular slit shape, and through the openings, the electromagnetic wave with desired frequency radiated by the electromagnetic wave radiation component 34 is selectively passed The shape of the opening can employ a different shape in accordance with a polarization of electromagnetic wave to be passed.

As described above, the opening with the slit shape of the embodiment illustrated in FIG. 3 is formed in the direction orthogonal to the polarization of the electromagnetic wave with desired frequency, in which the length of one side is set to half the wavelength of the electromagnetic wave with desired frequency radiated by the electromagnetic wave radiation component 34. Specifically, if the openings each having a length of half the wavelength are formed in the direction orthogonal to the polarization of the electromagnetic wave radiated to the outside from the shielding case, it becomes possible to make the electromagnetic wave with desired frequency to be selectively passed.

For example, when the polarization of the desired electromagnetic wave is a horizontal or vertical polarization, if the shape of the slit 22 is formed to have a square shape having a length being half the wavelength of desired frequency, the electromagnetic wave with either of the polarizations can be passed. Specifically, by setting each length of the vertical or horizontal side of each of the rectangular-shaped openings to half the wavelength of desired frequency, it becomes possible that the electromagnetic wave centered at the frequency is passed. Note that each of the center distances B1, C1 of the adjacent openings is desirably set to be shorter than the wavelength of desired frequency.

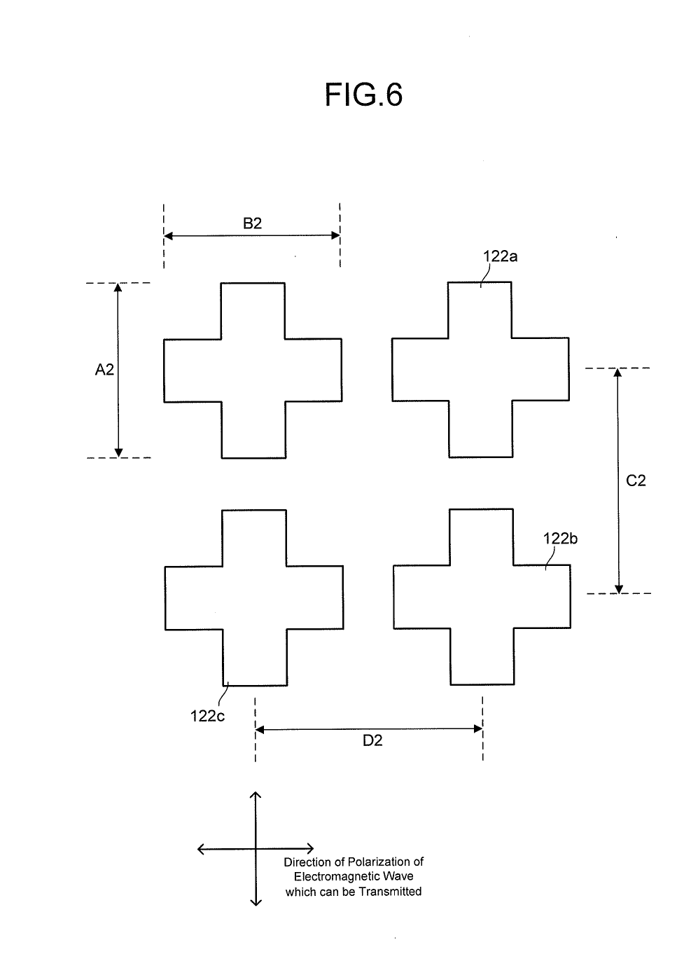

FIG. 6 is a diagram illustrating an example of electromagnetic wave radiation part 122 suitable for a case where the electromagnetic wave radiation component 34 radiates two electromagnetic waves whose polarizations are orthogonal to each other. As illustrated in FIG. 6, in the electromagnetic wave radiation part 122 of this example, each of openings 122a to 122c has a cross shape. Specifically, cross shapes each formed by combining a rectangular shape whose one side has a length A2 and a rectangular shape whose one side has a length B2, are formed on the conductor layer 20.

For example, the electromagnetic wave radiation part 122 illustrated in FIG. 6 is formed on the conductor layer 20 at a position corresponding to the electromagnetic wave radiation component 34. When it is set that each of the lengths A2 and B2 is half a wavelength of a desired electromagnetic wave radiated by the electromagnetic wave radiation component 34, and the electromagnetic wave radiation component 34 can radiate electromagnetic waves with the horizontal polarization (direction orthogonal to A2) and the vertical polarization (direction orthogonal to B2), the electromagnetic wave with either of the horizontal polarization and the vertical polarization can be passed through the electromagnetic wave radiation part 122. At this time, each of center distances C2, D2 of the adjacent openings is desirably set to be shorter than the wavelength of desired frequency.

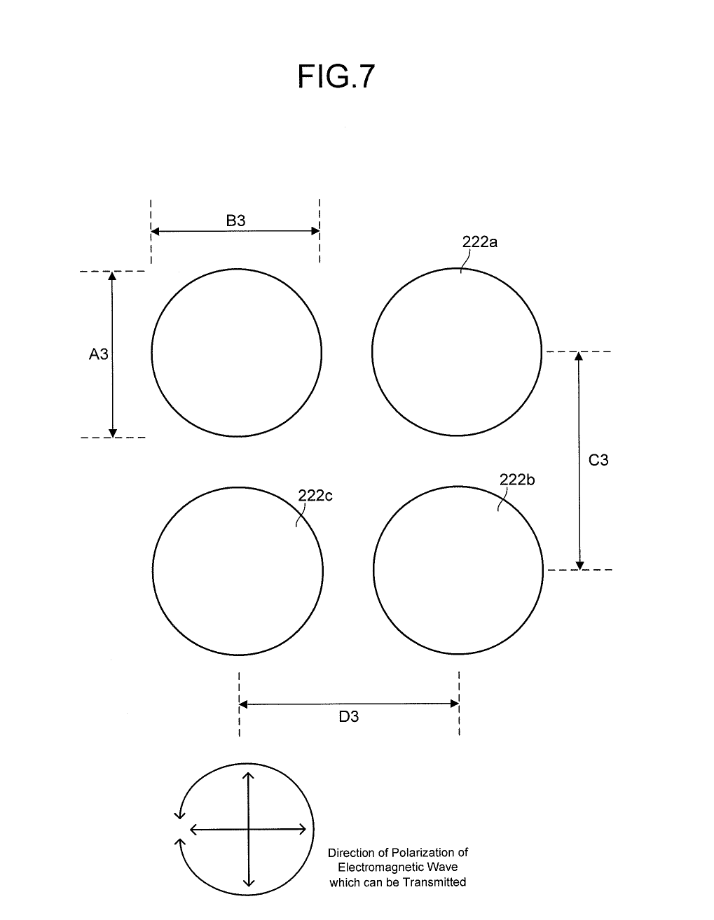

FIG. 7 is a diagram illustrating an example of electromagnetic wave radiation part 222 suitable for a case where the electromagnetic wave radiation component 34 radiates not only two electromagnetic waves whose polarizations are orthogonal to each other but also an electromagnetic wave of circular polarization. As illustrated in FIG. 7, the electromagnetic wave radiation part 222 of this example has openings having elliptical shapes 222a to 222c each having a major axis of A3 and a minor axis of B3.

For example, by setting each of the lengths of the major axis A3 and the minor axis B3 to half the wavelength of desired frequency radiated by the electromagnetic wave radiation component 34, a radio wave of arbitrary polarization, particularly the circular polarization, can be passed. At this time, each of center distances C3, D3 of adjacent openings is desirably set to be shorter than the wavelength of desired frequency.

Note that in the above description, it is explained that the plurality of electromagnetic waves having different polarizations at the same frequency are passed, but, the description is not limited to this. For example, if it is configured such that the lengths of the long side and the short side of the slit are set to half a wavelength of electromagnetic waves of two frequencies, respectively, and the electromagnetic wave radiation component 34 radiates the two electromagnetic waves with polarizations orthogonal to the slit with the corresponding lengths, each of the electromagnetic waves with different frequencies can be passed through the opening. The same applies to the openings of cross shape illustrated in FIG. 6 or of elliptical shape illustrated in FIG. 7, and if it is configured such that the lengths A2, B2 or the major axis A3 and the minor axis B3 are respectively set to half a wavelength of respective corresponding electromagnetic waves, and the electromagnetic wave radiation component 34 radiates the two electromagnetic waves with polarizations orthogonal to the rectangular shape or the axial direction with the corresponding lengths, different frequencies can be passed through the openings.

### Second Embodiment

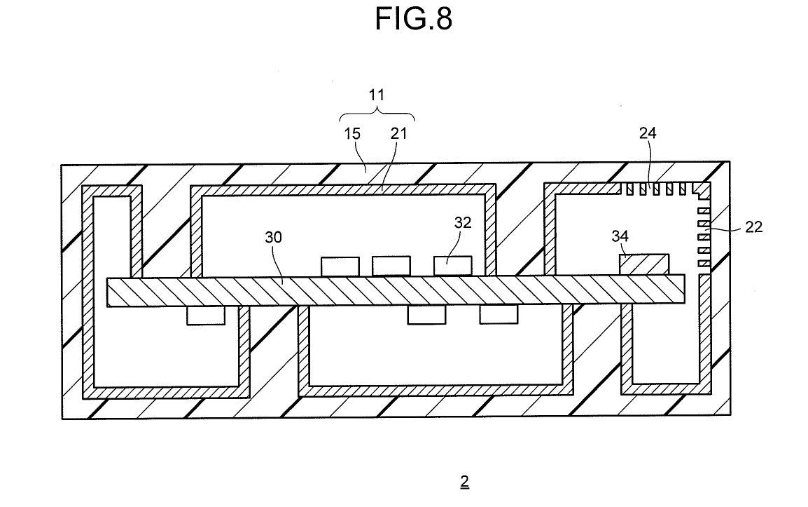

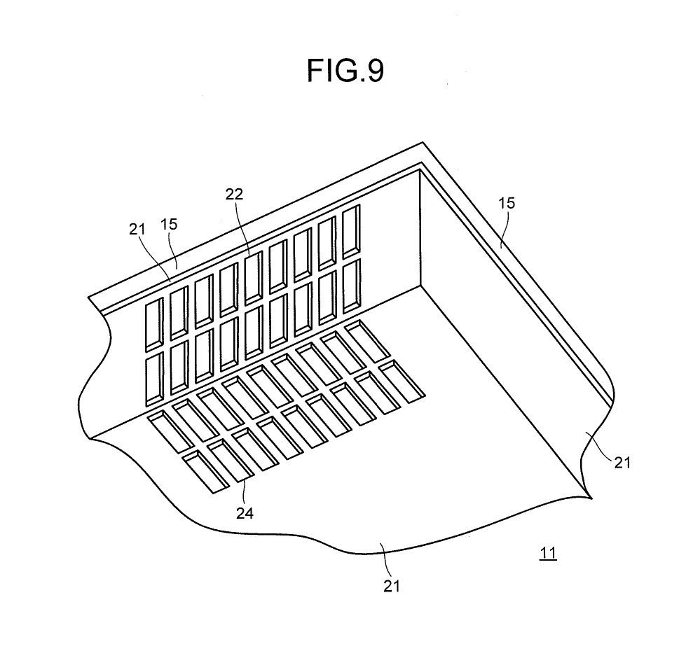

Next, another embodiment of the present invention will be described with reference to FIG. 8 and FIG. 9. In a radio apparatus 2 according to this embodiment, the electromagnetic wave radiation part of the shielding case of the embodiment illustrated in FIG. 1 and FIG. 2 is formed on a plurality of internal surfaces of the conductor layer. Accordingly, elements common to those of the embodiment illustrated in FIG. 1 and FIG. 2 are denoted by common reference numerals, and overlapped explanation thereof will be omitted.

As illustrated in FIG. 8 and FIG. 9, the radio apparatus 2 of this embodiment includes a shielding case 11 formed of a main body 15 made of a dielectric material and the like and a conductor layer 21 formed on an internal surface of the main body 15. The conductor layer 21 that forms the internal surface of the shielding case 11 has electromagnetic wave radiation parts 22 and 24 at positions corresponding to the electromagnetic wave radiation component 34.

The electromagnetic wave radiation parts 22 and 24 are provided by forming a plurality of slits, holes and the like on the conductor layer 21, and each of them has common configuration and function. Further, the electromagnetic wave radiation parts 22 and 24 are formed on a plurality of main surfaces (on walls) of the shielding case 11 to surround the electromagnetic wave radiation component 34. Specifically, in the shielding case 11 according to this embodiment, the electromagnetic wave radiation parts 22 and 24 are formed to surround the electromagnetic wave radiation component 34, so that it is possible to suppress attenuation of desired electromagnetic wave and an unwanted radiation radiated by the electromagnetic wave radiation component 34.

It should be noted that the present invention is not limited to the above-described embodiments as they are, and in an implementation stage, it can be embodied by modifying components thereof within a range not departing from the spirit of the invention. For example, the above embodiments describe that the shielding case houses the substrate on which the high-frequency circuit elements are mounted, but, they are not limited to this. Specifically, the shielding case may also be one that houses the high-frequency circuit elements themselves such as a coil element and a capacitor. Also, the plural components disclosed in the above-described embodiments can be appropriately combined to form various inventions. For example, some of all the components shown in the embodiments may be eliminated. Moreover, components from different embodiments may be combined appropriately.

Embodiments can be utilized in an electronic apparatus manufacturing industry and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio apparatus, comprising:
a substrate configured to have a high-frequency circuit formed thereon, the high-frequency circuit including an electromagnetic wave radiation source to radiate an electromagnetic wave; and
a shielding case configured to house the substrate, the shielding case having a plurality of openings each having a length of half a wavelength of the electromagnetic wave in a direction orthogonal to a polarization of the electromagnetic wave, the openings being provided respectively to make each distance between centers of the openings to be shorter than one wavelength of the electromagnetic wave.

2. The radio apparatus according to claim 1,
wherein the shielding case has a plurality of openings each having a rectangular shape and having a length of half the wavelength of the electromagnetic wave in a direction orthogonal to the polarization of the electromagnetic wave.

3. The radio apparatus according to claim 1,
wherein the shielding case has a plurality of openings each having a cross shape formed by making a rectangular shape having a length of half the wavelength of the electromagnetic wave in a direction orthogonal to the polarization of the electromagnetic wave and a rectangular shape having a length of half the wavelength of the electromagnetic wave in the same direction as that of the polarization of the electromagnetic wave to be orthogonal to each other.

4. The radio apparatus according to claim 1,
wherein the shielding case has a plurality of openings each having an elliptical shape and having a major axis or a minor axis whose length of half the wavelength of the electromagnetic wave in a direction orthogonal to the polarization of the electromagnetic wave.

5. The radio apparatus according to claim 1,
wherein the shielding case comprises a plurality of wall members arranged to surround the electromagnetic wave radiation source; and
wherein the plurality of wall members have a plurality of openings each having a length of half the wavelength of the electromagnetic wave in a direction orthogonal to the polarization of the electromagnetic wave, the openings being provided respectively to make each distance between centers of the openings to be shorter than one wavelength of the electromagnetic wave.

6. The radio apparatus according to claim 1,
wherein the electromagnetic wave radiation source radiates a first electromagnetic wave with a first polarization and a second electromagnetic wave with a second polarization orthogonal to the first polarization at a frequency different from that of the first electromagnetic wave; and
wherein the shielding case has a plurality of openings each having a cross shape formed by making a rectangular shape having a length of half a wavelength of the first electromagnetic wave in a direction orthogonal to the first polarization and a rectangular shape having a length of half a wavelength of the second electromagnetic wave in a direction orthogonal to the second polarization to be orthogonal to each other.

7. The radio apparatus according to claim 1,
wherein the electromagnetic wave radiation source radiates the electromagnetic wave to an outside of the shielding case via the openings of the shielding case.

8. The radio apparatus, according to claim 1,
wherein the shielding case suppresses a radiation of radiation noise whose frequency is lower than that of the electromagnetic wave.

9. The radio apparatus according to claim 1,
wherein the electromagnetic wave radiation source comprises a component with which radio communication is made via the openings of the shielding case.
